(19) United States
(12) Patent Application Publication
(10) Pub. No.: US 2021/0191684 A1
(43) Pub. Date: Jun. 24, 2021

(54) CONTROL METHOD, CONTROL DEVICE, CONTROL SYSTEM, ELECTRONIC WHITEBOARD, AND MOBILE TERMINAL

(71) Applicant: Shenzhen Hitevision Technology Co., Ltd., Shenzhen (CN)

(72) Inventor: Heng Zhang, Shenzhen (CN)

(21) Appl. No.: 17/003,580

(22) Filed: Aug. 26, 2020

(30) Foreign Application Priority Data
Dec. 23, 2019 (CN) 201911340718.4

(51) Int. Cl. G06F 3/14; H04L 29/06; G06F 3/041

(52) U.S. Cl. CPC G06F 3/1454; G06F 2203/04105; G06F 3/041; H04L 65/4015

(57) ABSTRACT

The present application provides a control method, a control device, a control system, an electronic whiteboard, and a mobile terminal. The electronic whiteboard performs a synchronous screen transfer with the mobile terminal to synchronize the electronic whiteboard with a display image of the mobile terminal. A touch message is generated based on the display image of the mobile terminal, and the electronic whiteboard receives the touch message transmitted by the mobile terminal. The electronic whiteboard obtains first touch data based on the touch message, and performs a touch operation based on the first touch data. The present application can achieve a control of the electronic whiteboard by the mobile terminal, thereby improving the convenience of operating the electronic whiteboard.

### CROSS-REFERENCE TO RELATED APPLICATION

This application is based on and claims priority to Chinese Patent Application No. 201911340718.4, filed on Dec. 23, 2019 and titled “CONTROL METHOD, CONTROL DEVICE, CONTROL SYSTEM, ELECTRONIC WHITEBOARD, AND MOBILE TERMINAL”, the contents of which are incorporated herein by reference in their entirety.

### FIELD

The present application relates to the technical field of information processing, and in particular, to a control method, a control device, a control system, an electronic whiteboard, and a mobile terminal.

### BACKGROUND

At present, electronic whiteboards have been widely used in teaching, conferences and other fields. A method of operating an electronic whiteboard is generally to operate the electronic whiteboard through touch or gestures directly, or to connect an external device such as a mouse and keyboard to the electronic whiteboard, and use the external device to operate the electronic whiteboard. In actual use, a teacher is unable to operate the electronic whiteboard due to walking in a classroom, which is inconvenient.

### SUMMARY

According to embodiments of the present application, there is provided a control method, a control device, a control system, an electronic whiteboard, and a mobile terminal.

According to a first aspect of the present application, there is provided a control method applied to an electronic whiteboard, including: performing a synchronous screen transfer with a mobile terminal to synchronize the electronic whiteboard with a display image of the mobile terminal; receiving a touch message transmitted by the mobile terminal, wherein the touch message is generated based on the display image of the mobile terminal; obtaining first touch data based on the touch message; and performing a touch operation based on the first touch data.

According to a second aspect of the present application, there is provided a control method applied to a mobile terminal, including: performing a synchronous screen transfer with an electronic whiteboard to synchronize the electronic whiteboard with a display image of the mobile terminal; generating a touch message based on the display image in response to a touch operation; and transmitting the touch message to the electronic whiteboard, wherein the touch message is used for the electronic whiteboard to obtain first touch data and perform a touch operation based on the first touch data.

According to a third aspect of the present application, there is provided a control device configured in an electronic whiteboard, including: a first screen transfer module configured to perform a synchronous screen transfer with a mobile terminal to synchronize the electronic whiteboard with a display image of the mobile terminal; a first data reception module configured to receive a touch message transmitted by the mobile terminal, wherein the touch message is generated based on the display image of the mobile terminal; a data processing module configured to obtain first touch data based on the touch message; and an execution module configured to perform a touch operation based on the first touch data.

According to a fourth aspect of the present application, there is provided a control device configured in a mobile terminal, including: a second screen transfer module configured to perform a synchronous screen transfer with an electronic whiteboard to synchronize the electronic whiteboard with a display image of the mobile terminal; a message generation module configured to generate a touch message based on the display image in response to a touch operation; and a second data transmission module configured to transmit the touch message to the electronic whiteboard, wherein the touch message is used for the electronic whiteboard to obtain first touch data based on the touch message and perform a touch operation based on the first touch data.

According to a fifth aspect of the present application, there is provided an electronic whiteboard, including a memory, a processor, and a computer program stored on the memory and executable on the processor, wherein the computer program, when executed by the processor, causes the processor to implement the method provided according to the first aspect of the present application.

According to a sixth aspect of the present application, there is provided a mobile terminal, including a memory, a processor, and a computer program stored on the memory and executable on the processor, wherein the computer program, when executed by the processor, causes the processor to implement the method provided according to the first aspect of the present application.

According to a seventh aspect of the present application, there is provided a control system, including the electronic whiteboard provided according to the fifth aspect of the present application and the mobile terminal provided according to the sixth aspect of the present application.

### BRIEF DESCRIPTION OF THE DRAWINGS

In order to describe technical solutions in embodiments of the present application or the prior art more clearly, drawings that require to be used in the description of the embodiments or the prior art will be briefly introduced below. Obviously, the drawings in the following description are only some embodiments of the present application, and for those of ordinary skill in the art, other drawings can be obtained based on these drawings without creative work.

FIG. 1 is a schematic flowchart of a control method applied to an electronic whiteboard according to an embodiment of the present application;

FIG. 2 is a schematic flowchart of a control method applied to a mobile terminal according to an embodiment of the present application;

FIG. 3 is a structural block diagram of a control device configured in an electronic whiteboard according to an embodiment of the present application;

FIG. 4 is a structural block diagram of a control device configured in a mobile terminal according to an embodiment of the present application;

FIG. 5 is a schematic structural diagram of a control system according to an embodiment of the present application; and

FIG. 6 is a schematic structural diagram of an electronic device according to an embodiment of the present application.

### DETAILED DESCRIPTION

In order to make the objectives, technical solutions, and advantages of the present application more clearly, the present application will be further described in detail in conjunction with specific embodiments and with reference to drawings.

It should be noted that, unless otherwise defined, technical terms or scientific terms used in the embodiments of the present application should have ordinary meanings understood by those with ordinary skills in the field to which the present application belongs. Words “first”, “second” and other similar words used in the present application do not indicate any order, quantity, or importance, but are only used to distinguish different components. Words “including” or “comprising” and other similar words mean that an element or item appearing before the words encompasses an element or item listed after the words and equivalents thereof, without excluding other elements or items. Words “connected” or “connecting” and other similar words are not limited to physical or mechanical connections, but may include electrical connections, whether direct or indirect. Words “up”, “down”, “left”, “right”, etc. are only used to indicate a relative position relationship. When an absolute position of a described object changes, then the relative position relationship may also change accordingly.

In an implementation, a teacher uses an electronic whiteboard for teaching in a classroom. The electronic whiteboard is widely recognized by the teacher and students because of its powerful functions, convenient operation, good interactive learning effects and other advantages. A method of operating the electronic whiteboard by the teacher is generally to operate the electronic whiteboard through touch or gestures, or to connect an external device such as a mouse and keyboard to the electronic whiteboard, and use the external device to operate the electronic whiteboard. Based on the above method of operating, the teacher can only operate near the electronic whiteboard, and the teacher is unable to operate the electronic whiteboard when the teacher is far away from the electronic whiteboard because of walking in the classroom.

In view of the above problems, the embodiments of the present application provide a control method, a control device, a control system, an electronic whiteboard, and a mobile terminal. The electronic whiteboard performs a synchronous screen transfer with the mobile terminal to synchronize the electronic whiteboard with a display image of the mobile terminal. When a user performs a touch operation on the mobile terminal, the mobile terminal generates a touch message in response to the touch operation and transmits the touch message to the electronic whiteboard. The electronic whiteboard receives the touch message transmitted by the mobile terminal, and then obtains first touch data based on the touch message, and performs a corresponding touch operation based on the first touch data. In this way, no matter where the teacher is in the classroom, the teacher can perform a touch operation on the electronic whiteboard through the mobile terminal, thereby improving the convenience of operating the electronic whiteboard.

The technical solutions provided by the embodiments of the present application will be described in detail below with reference to the drawings.

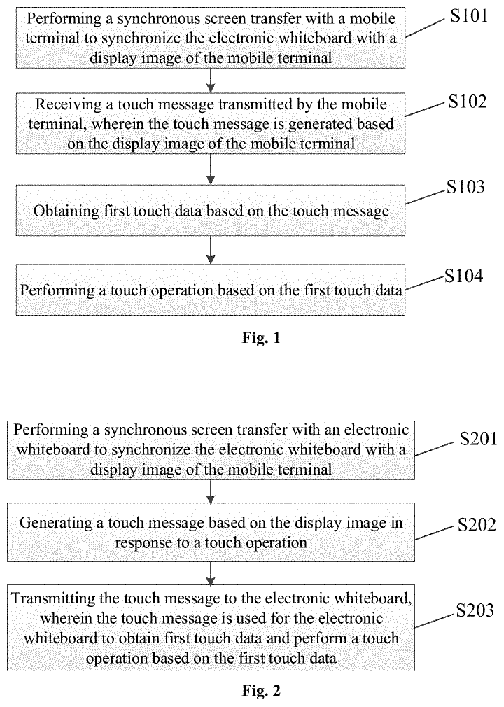

As shown in FIG. 1, a control method applied to an electronic whiteboard according to an embodiment of the present application may include steps S101, S102, S103 and S104.

In step S101, a synchronous screen transfer with a mobile terminal may be performed to synchronize the electronic whiteboard with a display image of the mobile terminal.

In the embodiment of the present application, the mobile terminal and the electronic whiteboard may perform a synchronous screen transfer. The electronic whiteboard may transmit a display image to the mobile terminal, so that the display image of the electronic whiteboard and the display image of the mobile terminal are synchronized. When a user performs a touch operation on the mobile terminal, the mobile terminal may “control” the electronic whiteboard to perform a touch operation. The synchronous screen transfer between the mobile terminal and the electronic whiteboard may be a wireless screen transfer or a wired screen transfer, which is not limited.

In this embodiment, the mobile terminal may include, but is not limited to, terminals with a touch operation function such as a smart phone, a touch laptop computer, and a tablet computer.

In a practical application, a teacher sits on a platform and operates a tablet computer. The tablet computer and the electronic whiteboard perform a wireless screen transfer. The tablet computer displays a same teaching plan image as the electronic whiteboard. The teacher can directly perform a touch operation on the teaching plan image on the tablet computer, and a corresponding touch operation can be performed on the electronic whiteboard, so as to achieve a control of the electronic whiteboard.

In step S102, a touch message transmitted by the mobile terminal may be received, wherein the touch message may be generated based on the display image of the mobile terminal.

In step S103, first touch data may be obtained based on the touch message.

In step S104, a touch operation may be performed based on the first touch data.

In the embodiment of the present application, after the synchronous screen transfer between the mobile terminal and the electronic whiteboard, the user can perform a touch operation based on the display image of the mobile terminal. When the user performs a touch operation, the mobile terminal may respond to the touch operation and generate the touch message, and the mobile terminal may transmit the touch message to the electronic whiteboard. The electronic whiteboard may receive the touch message, parse and process the touch message, and obtain the first touch data, and then perform a touch operation based on the first touch data, so as to use the mobile terminal to control the electronic whiteboard to perform a touch operation.

For example, the teacher performs a touch operation on the teaching plan image on the tablet computer, the touch operation may be, for example, clicking on courseware, dragging files, writing, erasing handwriting, etc. The tablet computer generates the touch message in response to the teacher's touch operation, and transmits the touch message to the electronic whiteboard. The electronic whiteboard receives the touch message transmitted by the tablet computer, parses and processes the touch message to obtain the first touch data, and performs a touch operation based on the first touch data.

In some implementations, the electronic whiteboard may be configured with a multimedia software such as a teaching software. The teaching software can achieve functions of writing, drawing, erasing, playing courseware, dragging courseware, zooming in and out, etc. In the classroom, the teacher can teach by operating the teaching software. By using the control method according to the embodiment of the present application, the teacher can use the mobile terminal to “control” the teaching software in the electronic whiteboard to perform a touch operation at any position in the classroom. First, the synchronous screen transfer between the electronic whiteboard and the mobile terminal may be achieved, so that the same image as an image of the teaching software on the electronic whiteboard is displayed on the mobile terminal. Then, the teacher can perform a touch operation based on the image on the mobile terminal. The mobile terminal may generate the touch message in response to the teacher's touch operation, and transmit the touch message to the electronic whiteboard. The electronic whiteboard may parse and process the received touch message to obtain the first touch data. The teaching software may perform an operation of a related function based on the first touch data, so as to achieve a control of the teaching software in the electronic whiteboard by the mobile terminal.

In the embodiment of the present application, using the mobile terminal to control the electronic whiteboard to perform a touch operation can be achieved in at least two ways.

One way is to perform a synchronous screen transfer step between the mobile terminal and the electronic whiteboard first. Then the electronic whiteboard may transmit a first display parameter to the mobile terminal. The mobile terminal may generate second touch data in response to a touch operation and generate the first touch data based on the first display parameter and the second touch data, and then encapsulate the first touch data as the touch message based on a predetermined protocol. The mobile terminal may transmit the touch message encapsulated based on the predetermined protocol to the electronic whiteboard. The electronic whiteboard may receive the touch message, parse the touch message to obtain the first touch data, and then perform a touch operation based on the first touch data.

In some embodiments, the first display parameter may include a height and a width of a display area of the electronic whiteboard.

In this embodiment, the mobile terminal may receive the first display parameter, and determine a scaling factor of the display image based on the height and width of the display area of the electronic whiteboard, and a height and a width of a display area of the mobile terminal itself. The mobile terminal may receive the display image transmitted by the electronic whiteboard, and then process the display image based on the scaling factor to obtain and display the display image of the mobile terminal.’

The scaling factor may be calculated as follows:

$$\frac{w 1}{w 2} = k \frac{h 1}{h 2} \qquad ( 1 )$$

wherein, w1 is the width of the display area of the electronic whiteboard, h1 is the height of the display area of the electronic whiteboard, w2 is the width of the display area of the mobile terminal, h1 is the height of the display area of the mobile terminal, and k is the scaling factor.

The user may perform a touch operation based on the display image of the mobile terminal. The mobile terminal may generate second touch data in response to the touch operation. The second touch data may include display data of the mobile terminal. The mobile terminal may process the display data based on the scaling factor to generate the scaled display data. The scaled display data may be encapsulated as the first touch data into the touch message based on the predetermined protocol for transmission to the electronic whiteboard. The scaled display data may be display data suitable for display on the electronic whiteboard. The electronic whiteboard may receive the touch message, parse the touch message to obtain the scaled display data, and display based on the scaled display data.

In this embodiment, the predetermined protocol may be, for example, a Table-Top User Interfaces Objects (TUIO) protocol.

Another way is to perform a synchronous screen transfer step between the mobile terminal and the electronic whiteboard first. Then the mobile terminal may transmit a second display parameter to the electronic whiteboard. The mobile terminal may generate the touch message in response to a touch operation, and may transmit the touch message to the electronic whiteboard. The electronic whiteboard may receive the touch message transmitted by the mobile terminal, generate the first touch data based on the touch message and the second display parameter, and then perform a touch operation based on the first touch data.

In some embodiments, the second display parameter may include the height and width of the display area of the mobile terminal.

In this embodiment, the mobile terminal may generate the touch message in response to a touch operation, and transmit the touch message to the electronic whiteboard. The electronic whiteboard may receive the touch message transmitted by the mobile terminal, parse the touch message to obtain the second touch data of the mobile terminal, generate the first touch data based on the second touch data and the second display parameter, and then perform a touch operation based on the first touch data.

Optionally, the electronic whiteboard may receive the second display parameter of the mobile terminal, and determine a scaling factor of the display image based on the height and width of the display area of mobile terminal, and the height and width of the display area of the electronic whiteboard itself. The electronic whiteboard may parse out the second touch data of the mobile terminal, wherein the second touch data may include display data of the mobile terminal. The electronic whiteboard may process the display data of the mobile terminal based on the scaling factor to generate the scaled display data. The electronic whiteboard may display based on the scaled display data.

In some implementations, the user may perform a writing touch operation based on the display image of the mobile terminal. The mobile terminal may generate the second touch data in response to the writing touch operation. The second touch data may also include handwriting data and pressure sensing data, and the handwriting data and pressure sensing data may be encapsulated as the first touch data into the touch message based on the predetermined protocol for transmission to the electronic whiteboard. The electronic whiteboard may receive the touch message, parse the touch message to obtain the handwriting data and pressure sensing data, determine a handwriting thickness level based on the pressure sensing data, and display a writing track based on the handwriting data and handwriting thickness level. Since the electronic whiteboard generally adopts an analog pressure sensing method such as a pressure sensing method, and an infrared method, etc., to achieve acquisition and display of a handwriting position, by using the method according to this embodiment, a corresponding writing track may be displayed based on the handwriting data and pressure sensing data of the mobile terminal, so as to achieve an effect of performing a writing touch operation on the mobile terminal and controlling the electronic whiteboard for writing.

It can be seen that the control method according to the embodiment of the present application can achieve a synchronization of the display image of the mobile terminal and the display image of the electronic whiteboard. When the user operates the mobile terminal, a control of the electronic whiteboard by the mobile terminal can be achieved. In this way, even if the user is far away from the electronic whiteboard, the user can also control the electronic whiteboard through the mobile terminal, which improves the convenience of operating the electronic whiteboard.

As shown in FIG. 2, a control method applied to a mobile terminal according to an embodiment of the present application may include steps S201, S202, and S203.

In step S201, a synchronous screen transfer with an electronic whiteboard may be performed to synchronize the electronic whiteboard with a display image of the mobile terminal.

In step S202, a touch message may be generated based on the display image in response to a touch operation.

In step S203, the touch message may be transmitted to the electronic whiteboard, wherein the touch message is used for the electronic whiteboard to obtain first touch data and perform a touch operation based on the first touch data.

The method applied to the mobile terminal of this embodiment corresponds to the method applied to the electronic whiteboard describe above. Corresponding technical details and technical effects have been recited in the embodiment of the method applied to the electronic whiteboard, and will not be repeated herein.

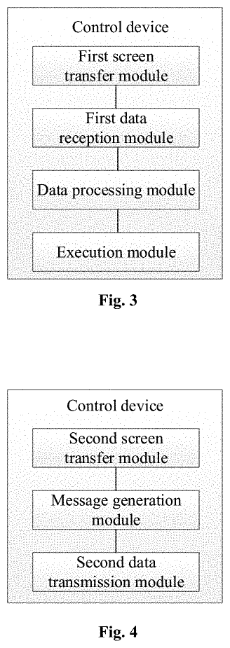

As shown in FIG. 3, according to an embodiment of the present application, there is also provided a control device configured in an electronic whiteboard, and the control device may include a first screen transfer module, a first data reception module, a data processing module and an execution module.

The first screen transfer module may be configured to perform a synchronous screen transfer with a mobile terminal to synchronize the electronic whiteboard with a display image of the mobile terminal.

The first data reception module may be configured to receive a touch message transmitted by the mobile terminal, wherein the touch message may be generated based on the display image of the mobile terminal.

The data processing module may be configured to obtain first touch data based on the touch message.

The execution module may be configured to perform a touch operation based on the first touch data.

In some possible embodiments, the first screen transfer module may be configured to transmit a first display parameter to the mobile terminal, and the first display parameter may be used for the mobile terminal to generate the first touch data.

In this embodiment, the first display parameter may include a height and a width of a display area of the electronic whiteboard.

In some possible embodiments, the data processing module may be configured to determine a second display parameter, and generate the first touch data based on the touch message and the second display parameter.

The second display parameter may include a height and a width of a display area of the mobile terminal.

In some possible embodiments, the first touch data may include handwriting data and pressure sensing data.

The execution module may be configured to determine a handwriting thickness level based on the pressure sensing data, and display a writing track based on the handwriting data and the handwriting thickness level.

The control device according to the embodiment described above can be used to implement the corresponding control method applied to the electronic whiteboard in the foregoing embodiment, and has beneficial effects of the corresponding method embodiment, which will not be repeated herein.

As shown in FIG. 4, according to an embodiment of the present application, there is also provided a control device configured in a mobile terminal, and the control device may include a second screen transfer module, a message generation module, and a second data transmission module.

The second screen transfer module may be configured to perform a synchronous screen transfer with an electronic whiteboard to synchronize the electronic whiteboard with a display image of the mobile terminal.

The message generation module may be configured to generate a touch message based on the display image in response to a touch operation.

The second data transmission module may be configured to transmit the touch message to the electronic whiteboard, wherein the touch message may be used for the electronic whiteboard to obtain first touch data based on the touch message, and perform a touch operation based on the first touch data.

In some possible embodiments, the second screen transfer module may be configured to receive a first display parameter transmitted by the electronic whiteboard.

In some possible embodiments, the message generation module may be configured to generate second touch data in response to the touch operation, generate the first touch data based on the second touch data and the first display parameter, and encapsulate the first touch data as the touch message based on a predetermined protocol.

In this embodiment, the first display parameter may include a height and a width of a display area of the electronic whiteboard.

In some possible embodiments, the second screen transfer module may be configured to transmit a second display parameter to the electronic whiteboard, wherein the second display parameter may be used for the electronic whiteboard to generate the first touch data based on the touch message and the second display parameter.

In this embodiment, the second display parameter may include a height and a width of a display area of the mobile terminal.

The control device according to the embodiment described above can be used to implement the corresponding control method applied to the mobile terminal in the foregoing embodiment, and has beneficial effects of the corresponding method embodiment, which will not be repeated herein.

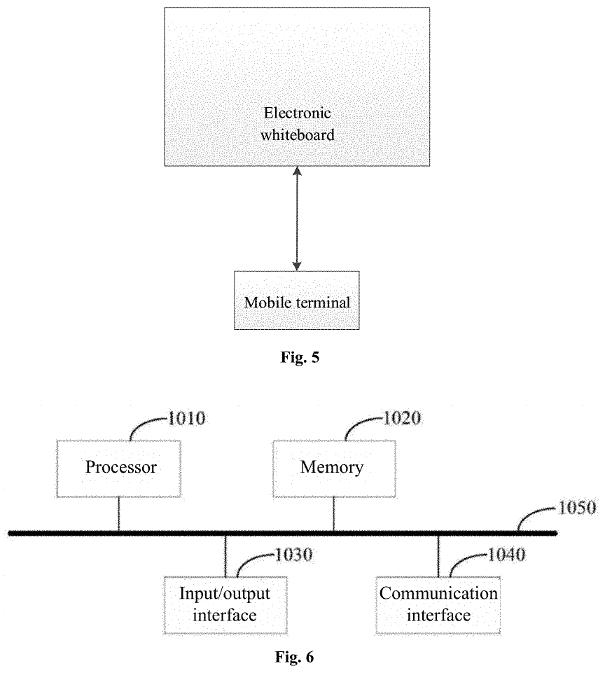

As shown in FIG. 5, according to an embodiment of the present application, there is also provided a control system including the electronic whiteboard and the mobile terminal as described above.

It should be noted that, the methods according to the embodiments of the present application may be performed by a single device, such as a computer or server, etc. The methods according to the embodiments of the present application may also be applied in a distributed scenario where a plurality of devices cooperate with each other to complete the methods. In the case of such a distributed scenario, one of the plurality of devices may only perform one or more steps in the methods according to the embodiments of the present application, and the plurality of devices will interact with each other to complete the methods.

FIG. 6 shows a more specific schematic diagram of a hardware structure of an electronic device provided by the embodiments of the present application. The device may include a processor 1010, a memory 1020, an input/output interface 1030, a communication interface 1040, and a bus 1050. The processor 1010, the memory 1020, the input/output interface 1030, and the communication interface 1040 may achieve a communication connection between each other in the device through the bus 1050.

The processor 1010 may be implemented by a general CPU (Central Processing Unit), a microprocessor, an Application Specific Integrated Circuit (ASIC), or one or more integrated circuits, etc., for executing related programs to implement the technical solutions provided by the embodiments of the present application.

The memory 1020 may be implemented in the form of a ROM (Read Only Memory), RAM (Random Access Memory), a static storage device, a dynamic storage device, etc. The memory 1020 may store an operating system and other application programs. When the technical solutions provided by the embodiments of the present application are implemented through a software or firmware, related program codes may be stored in the memory 1020 and may be called by the processor 1010 for execution.

The input/output interface 1030 may be used to connect an input/output module to enable information input and output. The input/output module may be configured in the device as a component (not shown in the figure), or may be external to the device to provide corresponding functions. An input module may include a keyboard, a mouse, a touch screen, a microphone, various sensors, etc., and an output module may include a display, a speaker, a vibrator, an indicator light, etc.

The communication interface 1040 may be used to connect a communication module (not shown in the figure) to achieve a communication interaction between the device and other devices. The communication module may achieve a communication through wired means (such as a USB, network cable, etc.), or through wireless means (such as a mobile network, WIFI, Bluetooth, etc.).

The bus 1050 may include a path for transmitting information between various components of the device (for example, the processor 1010, the memory 1020, the input/output interface 1030, and the communication interface 1040).

It should be noted that, although the above device only shows the processor 1010, the memory 1020, the input/output interface 1030, the communication interface 1040, and the bus 1050, the device may also include other components necessary to achieve a normal operation in a specific implementation process. In addition, those skilled in the art can understand that the above-described device may also include only components necessary to implement the solutions of the embodiments of the present application, rather than all the components shown in the figures.

Computer-readable media of the embodiments of the present application may include permanent and non-permanent, removable and non-removable media, and information storage may be achieved by any method or technology. The information may be a computer-readable instruction, a data structure, a module of a program, or other data. Examples of computer storage media may include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a magnetic cassette, a magnetic tape/magnetic disk storage or other magnetic storage devices or any other non-transmission media capable of storing information that can be accessed by a computing device.

Those of ordinary skill in the art should understand that, the discussions with respect to any of the above embodiments are only exemplary, and are not intended to imply that the scope of the present application (including the claims) is limited to these examples. Under the idea of the present application, technical features in the above embodiments or different embodiments may also be combined, steps may be implemented in any order, and there are many other changes in different aspects of the present application as described above, which are not provided in detail for the sake of brevity.

In addition, in order to simplify the description and discussion, and in order not to make the present application difficult to understand, well-known power/ground connections with an integrated circuit (IC) chip and other components may or may not be shown in the drawings provided. In addition, the devices may be shown in the form of block diagrams in order to avoid making the present application difficult to understand, and this also takes into account the fact that details of implementations of devices in these block diagrams are highly dependent on a platform on which the present application will be implemented (i.e., these details should be fully within the understanding of those skilled in the art). In the case where specific details (for example, circuits) are set forth to describe exemplary embodiments of the present application, it is obvious to those skilled in the art that the present application may be implemented without these specific details or in the case that these specific details have changes. Therefore, these descriptions should be considered illustrative rather than restrictive.

Although the present application has been described in conjunction with the specific embodiments of the present application, many substitutions, modifications and variations of these embodiments will be apparent to those of ordinary skill in the art based on the foregoing description. For example, other memory architectures (for example, a dynamic RAM (DRAM)) may use the discussed embodiments.

The embodiments of the present application are intended to cover all such substitutions, modifications, and variations that fall within a broad scope of the appended claims. Therefore, any omission, modification, equivalent substitution, improvement, etc. made within the spirit and principles of the present application shall fall within a protection scope of the present application.

1. A control method applied to an electronic whiteboard, comprising:
performing a synchronous screen transfer with a mobile terminal to synchronize the electronic whiteboard with a display image of the mobile terminal;
receiving a touch message transmitted by the mobile terminal, wherein the touch message is generated based on the display image of the mobile terminal;
obtaining first touch data based on the touch message; and
performing a touch operation based on the first touch data.

2. The method of claim 1, wherein the performing the synchronous screen transfer with the mobile terminal comprises:
transmitting a first display parameter to the mobile terminal, wherein the first display parameter comprises a height and a width of a display area of the electronic whiteboard, and the first display parameter is used for the mobile terminal to generate the first touch data.

3. The method of claim 1, wherein the obtaining the first touch data based on the touch message comprises:
determining a second display parameter, wherein the second display parameter comprises a height and a width of a display area of the mobile terminal; and
generating the first touch data based on the touch message and the second display parameter.

4. The method of claim 1, wherein the first touch data comprises handwriting data and pressure sensing data, and the performing the touch operation based on the first touch data comprises:
determining a handwriting thickness level based on the pressure sensing data; and
displaying a writing track based on the handwriting data and the handwriting thickness level.

5. A control method applied to a mobile terminal, comprising:
performing a synchronous screen transfer with an electronic whiteboard to synchronize the electronic whiteboard with a display image of the mobile terminal;
generating a touch message based on the display image in response to a touch operation; and
transmitting the touch message to the electronic whiteboard, wherein the touch message is used for the electronic whiteboard to obtain first touch data and perform a touch operation based on the first touch data.

6. The method of claim 5, wherein the performing the synchronous screen transfer with the electronic whiteboard comprises:
receiving a first display parameter transmitted by the electronic whiteboard, wherein the first display parameter comprises a height and a width of a display area of the electronic whiteboard.

7. The method of claim 6, wherein the generating the touch message based on the display image in response to the touch operation comprises:
generating second touch data in response to the touch operation;
generating the first touch data based on the second touch data and the first display parameter; and
encapsulating the first touch data as the touch message based on a predetermined protocol.

8. The method of claim 5, wherein the performing the synchronous screen transfer with the electronic whiteboard comprises:
transmitting a second display parameter to the electronic whiteboard, wherein the second display parameter comprises a height and a width of a display area of the mobile terminal, and the second display parameter is used for the electronic whiteboard to generate the first touch data based on the touch message and the second display parameter.

9. A control device configured in an electronic whiteboard, comprising:
a processor; and
a memory for storing instructions executable by the processor,
wherein the processor is configured to perform the method of claim 1.

10. A control device configured in a mobile terminal, comprising:
a processor; and
a memory for storing instructions executable by the processor,
wherein the processor is configured to perform the method of claim 5.

11. An electronic whiteboard, comprising a memory, a processor, and a computer program stored on the memory and executable on the processor, wherein the computer program, when executed by the processor, causes the processor to implement the method of claim 1.

12. A mobile terminal, comprising a memory, a processor, and a computer program stored on the memory and executable on the processor, wherein the computer program, when executed by the processor, causes the processor to implement the method of claim 5.

13. A control system, comprising the electronic whiteboard of claim 11 and a mobile terminal, wherein the mobile terminal comprises a memory, a processor, and a computer program stored on the memory and executable on the processor, wherein the computer program, when executed by the processor, causes the processor to:
perform a synchronous screen transfer with the electronic whiteboard to synchronize the electronic whiteboard with a display image of the mobile terminal;
generate a touch message based on the display image in response to a touch operation; and
transmit the touch message to the electronic whiteboard, wherein the touch message is used for the electronic whiteboard to obtain first touch data and perform a touch operation based on the first touch data.
